(19) United States
(12) Patent Application Publication
(10) Pub. No.: US 2022/0408737 A1
(43) Pub. Date: Dec. 29, 2022

(54) HIGH-ACID BAKED GOOD AND METHOD OF MAKING BAKED GOOD

(71) Applicant: Intercontinental Great Brands LLC, East Hanover, NJ (US)

(72) Inventors: Lynn Haynes, East Hanover, NJ (US); Harshil Khamar, East Hanover, NJ (US); Ana Beatriz Manrique Rodriguez, East Hanover, NJ (US)

(21) Appl. No.: 17/781,368

(22) PCT Filed: Nov. 30, 2020
(86) PCT No.: PCT/US2020/062593

§ 371 Date: May 31, 2022

Related U.S. Application Data
(60) Provisional application No. 62/944,904, filed on Dec. 6, 2019.

(51) Int. Cl. A21D 2/14; A21D 2/02

(52) U.S. Cl. CPC A21D 2/145; A21D 2/02

(57) ABSTRACT

Biscuits such as cookies are provided having high acidity but retaining desirable flavor, texture, and appearance after baking. The biscuits may optionally comprise inclusions. Anionic salt concentration is controlled in order to maintain moisture and density similar to those of normal biscuits despite relatively high concentrations of flavor acids.

### FIELD

The present disclosure relates to baked food products having high acidity, and methods of making such products.

### BACKGROUND

Baked goods come in a variety of forms, with varying appearances, textures, flavors, and other characteristics. In particular, biscuits such as cookies and the like are provided in a variety of shapes, sizes, and thicknesses, and may optionally contain one or more of a wide variety of inclusions or toppings. Inclusions vary the texture and/or flavor of the cookie, providing added crunch, chewiness, or other characteristics. Inclusions such as nuts and chocolate chips have long been traditional ingredients in cookie making, and provide a pleasant sweet or salty flavor in addition to variance in texture. As consumer preferences evolve, it is desirable to offer a wider array of texture and flavor options. For instance, in addition to traditional sweet or salty inclusions, it may be desirable to offer cookies with added sour notes.

However, manufacturing cookies having certain flavors or other properties requiring high acidity is problematic because formulation of a dough to produce an acidic baked product can present difficulties and is generally disfavored. Acids can interfere with Maillard reactions during baking. Excess acid in dough is thought to reduce the nucleophilicity of amino groups in amino acids and peptides and inhibit condensation of these compounds with sugars during the initial stages of Maillard reaction when undergoing Schiff base formation. Schiff base formation is the most important step of the Maillard reaction. Furthermore, low pH enhances acid-catalyzed sugar degradation and promotes off flavor and product discoloration during baking. Low pH is also thought to inhibit formation of melanoidins. Melanoidins are macromolecular, nitrogenous, and brown-colored final products of the Maillard reactions between reducing sugars and proteins or amino acids. Melanoidins are of particular interest to the food industry because the brown color imparted by these compounds is intimately associated in consumers' minds with a high-grade product. Studies have shown that pH is an important factor that influences the formation and structure of the melanoidins (H.Y. Wang et al., Food Chemistry 128 (2011) 573-584). The inhibition of Maillard reactions can reduce development of desirable flavor normally associated with baked goods. Addition of flavor acid to dough can also produce undesirable patterns and/or discoloration, e.g. brown speckling, on a surface of a baked good due to thermal degradation of added flavor acids.

Further, it is thought that many acids can promote gelling of proteins, e.g. whey protein, within dough. Increased protein gelling is thought to inhibit both spread of dough and moisture removal during baking. Insufficient spread and moisture removal during baking can pose problems when trying to produce a baked good having specific dimensions, texture, and weight characteristics. The interaction of acids with proteins results in incorrect cookie moisture at critical stages of baking and can work to inhibit formation of normal Maillard baked flavor and color.

It would be desirable to enable the manufacture of a dough to provide a baked good having not only high acidity but also desirable coloration and flavor normally associated with a baked good. It would also be desirable for an acidic dough to provide satisfactory spreading and moisture removal during baking.

### SUMMARY

Baked goods may be provided that have high acidity. In some forms, the baked good may include acidic or sour flavors, or a combination of sour and other flavors, such as sweet and sour or sour and salty flavors. Doughs for making such baked goods are also described herein. Optionally, inclusions may be incorporated into the dough and final baked good. In one aspect, provided herein are biscuits, such as cookies, prepared from a dough comprising, not accounting for inclusions, 30 to 60 wt % of flour 15 to 30 wt % of fat, 10 to 30 wt % of sweetener, 0.25 to 2.0 wt % of material derived from one or more acids or salts thereof having a pKa of less than 6.5, and a total bicarbonate ion and dihydrogen phosphate ion concentrations ranging from 4 g/100 g of flour to 6.5 g/100 g flour. In some forms, the invention may further include 15-35 wt. % inclusions. Biscuits having total bicarbonate ion and dihydrogen phosphate ion concentrations ranging from 4 g/100 g of flour to 6.5 g/100 g flour tend to provide satisfactory moisture removal and density after baking, similar to low-acid biscuits. Below this range, biscuits tend to have undesirably high moisture and density. Above 6.5 g/100 g flour, biscuits develop off flavors, texture becomes fragile, and the biscuit falls apart.

In another aspect, methods of making a dough or biscuit are provided. In some aspects, such methods may comprising, for instance, dissolving one or more acids or salts thereof in water to form an acidic solution. In some forms, the one or more acids or salts thereof having a pKa of less than 6.5, and the acidic solution may be added to components of the dough during mixing.

### BRIEF DESCRIPTION OF THE DRAWINGS

FIG. 1 is a process flow diagram of an embodiment of a method of making a baked good;

FIG. 2 is a graph showing a relationship between moisture and total concentration of bicarbonate ions and dihydrogen phosphate ions in embodiments of a cookie; and

FIG. 3 is a graph showing a relationship between density and total concentration of bicarbonate ions and dihydrogen phosphate ions in embodiments of a cookie.

### DETAILED DESCRIPTION

It has now been found that a biscuit, e.g. cookie, can be prepared from a dough comprising significant amounts of material derived from one or more acids or salts thereof to provide the biscuit with a desirable sour taste, texture, and appearance and still permit desirable spread during baking. In some forms, a biscuit, e.g. cookie, can generally comprise flour, fat, sweetener, and material derived from one or more acids or salts thereof. A biscuit can further optionally comprise inclusions.

Generally, a biscuit can be prepared from a dough including any one or more suitable flours such as all-purpose flour, cake flour, climax flour, bread flour, gluten-free flour, graham flour, oat flour, pastry flour, rice flour, self-rising flour, tapioca flour, wheat flour, white whole-wheat flour, or whole-wheat flour. A biscuit can generally include any suitable amount of flour. In some aspects, a biscuit can be prepared from a dough comprising one or more types of flour in amounts ranging from about 30 to about 60 wt %, about 35 to about 55 wt %, or about 40 to about 50 wt % of a total weight of the dough.

In some aspects, a biscuit can be prepared from a dough comprising a combination of graham flour and wheat four, e.g. pastry flour. Graham flour includes coarse particles and bran (including glutathione and minerals such as ash). Without intending to be bound by any particular theory, it is thought that the coarse particles and bran of graham flour inhibit acid-induced network formation in an acidic dough and promote spread during baking. In some embodiments, a biscuit can be prepared from a dough comprising a weight ratio of graham flour to wheat flour ranging from about 40:60 to about 60:40, ranging from about 45:55 to about 55:45, or about 50:50.

A biscuit can be prepared from a dough optionally including one or more starches such as native corn starch, corn starch, native rice starch, native wheat starch, potato starch, wheat starch, tapioca starch, and pre-gelled forms of such starches. In some aspects, a biscuit can be prepared from a dough including one or more starches in any suitable amount such as about 1 to about 20 wt %, about 2 to about 15 wt %, about 3 to about 10 wt %, or about 4 to about 5 wt % of a total weight of the dough. In some aspects, pre-gelled starch can be added in small quantities to attenuate cookie spread, preferably about 0.25-1.5% and more preferably about 1%. It is also generally thought that a dough comprising both dissolved sugar and native wheat starch, to dilute gluten, will reduce starch polymer swelling and gelatinization. In some aspects, the amount of sugar and water in the formula and the order of ingredient addition aids dissolution of sugar. In some embodiments, the final sugar-water solution is about 50-67.6% sugar, or 60-67.6% sugar. In other embodiments, the final sugar-water solution is saturated with sugar (about 67.6% sugar at about 20° C.).

A biscuit can also be prepared from a dough including added fiber. In some aspects, useful fiber includes any one or more of soluble fiber and insoluble fiber. Examples of fiber include corn bran, guar gum, oat bran, oat fiber, inulin, polydextrose, rice bran, or wheat bran. However, inulin is thought to adversely affect dough spread during baking and cause undesirable discoloration of baked goods, when inulin is included in a dough comprising material derived from one or more acids or salts thereof. Therefore, in some embodiments a biscuit is prepared from a dough comprising material derived from one or more acids or salts thereof and substantially no inulin, or no inulin at all.

A biscuit also can be prepared from a dough optionally including one or more of a carbonate salt and a bicarbonate salt. Without intending to be bound by any particular theory it is generally thought that one or more of carbonate and bicarbonate salts can aid with moisture removal, improving the texture and quality of the baked good, and can also contribute to spread during baking. Examples of useful carbonate and bicarbonate salts include calcium carbonate, sodium carbonate, potassium carbonate, sodium bicarbonate (baking soda), potassium bicarbonate, ammonium carbonate, and ammonium bicarbonate. In some embodiments, a dough includes about 0.45% sodium bicarbonate (soda) and about 0.36% ammonium bicarbonate to effect normal leavening behavior in the dough. In some cases, greater amounts of soda and ammonium bicarbonate can result in a biscuit having a chalky texture or a biscuit that is extremely fragile and prone to breakage. In some aspects, a dough can include one or more of a carbonate salt and a bicarbonate salt in a total amount ranging from 1 g/100 g flour to 5 g/100 g flour, 2 g/100 g flour to 4 g/100 g flour, or 3 g/100 g flour to 4 g/100 g flour. In some aspects, a dough can include one or more of a carbonate salt and a bicarbonate salt in cumulative proportions ranging from about 0.5 to about 2.0 wt %, about 0.7 to about 1.8 wt %, or about 1.2 to about 1.6 wt % of a total weight of the dough.

A dough can optionally include any one or more leavening agents. Suitable leavening agents include ammonium, sodium, and potassium bicarbonates, sodium and potassium phosphates, ammonium phosphate dibasic, ammonium phosphate monobasic, calcium dihydrogen phosphate, diammonium hydrogen phosphate, disodium pyrophosphate, glucono delta-lactone, kefir, monocalcium phosphate (calcium acid phosphate), potassium bitartrate (cream of tartar), sourdough starter, whipping cream, or yeast.

It has been generally recognized in the baking arts that adding one or more of a carbonate salt and a bicarbonate salt to a dough can undesirably neutralize material derived from one or more acids or salts thereof that is useful for imparting sour flavor. It has unexpectedly been found that addition of one or more of a carbonate salt and a bicarbonate salt (e.g. sodium bicarbonate) along with an acidic leavening agent (e.g. calcium acid phosphate) can establish a system that prevents neutralization of the acidity of the baked product and provides improved texture and moisture at high levels of acid. In some forms, acidic leavening agents may comprise acid phosphates such as monocalcium phosphate, disodium pyrophosphate, sodium aluminum phosphate, and potassium phosphates In some aspects, a dough can include one or more acidic leavening agents in an amount ranging from about 0.5 g/100 g flour to 4 g/100 g flour, 1 g/100 g flour to 3 g/100 g flour, or 1.5 g/100 g flour to 2.5 g/100 g flour. In some aspects, a dough can include one or more acidic leavening agents in an amount ranging from about 0.6 to about 1.4 wt %, or about 0.7 to about 1.0 wt %, of a total weight of the dough.

Generally, to some extent it is thought that integrity of a baked good depends on the degree of protein association and networking within the baked good. Dough including an acidic component can produce a baked good having excessive protein networking and gelling, which can negatively affect moisture removal and dough spread during baking, crumb development, and final texture of a baked good. It has surprisingly been found that including one or both of an acidic leavening agent (e.g. acid phosphate salts) and a carbonate/bicarbonate salt in an acidic dough can mediate protein network formation and assist with normal crumb development. Without intending to be bound by any particular theory, it is generally thought that acidic leavening agent and one or more of a carbonate salt and a bicarbonate salt can aid with moisture removal, spread during baking, and improvement of texture of a baked good. In some embodiments, a dough can include one or more acid phosphates in an amount ranging from about 1 g/100 g flour to 3 g/100 g flour, 1.5 g/100 g flour to 2.5 g/100 g flour. Integrity of the finished cookie matrix depends on protein development and association into networks, and anionic salts including phosphates mediate the network formation and assist with normal crumb development when delivering an acidic product. The complex nature of proteins, having multiple ionizable groups and nonpolar functional groups, makes it difficult to develop a combination of salts, especially for a dough including added acids for flavor, that provide the correct environment for protein hydration and association. Without intending to be bound by any particular theory it is generally thought that one or more of the bicarbonates and acid phosphate salts can aid with moisture removal, improving the texture and quality of the baked good, and can also contribute to spread during baking.

Generally, a biscuit can be prepared from a dough including any one or more suitable fats. Without limitation, such fats may include solid fats or oils such as avocado oil, butter, canola oil, cocoa butter, coconut oil, corn oil, cottonseed oil, flaxseed oil, grape seed oil, lard, margarine, olive oil, palm kernel oil, palm oil, peanut oil, rapeseed oil, rice bran oil, safflower oil, sesame oil, soybean oil, suet, sunflower oil, tallow, vegetable oil, or vegetable shortening. In some aspects, a dough or biscuit can include a blend of any two or more fats. In an embodiment, a dough and biscuit comprise a blend of canola oil and palm oil. A dough can generally include fat in any useful amount such as amounts ranging from about 15 to about 30 wt %, or about 20 to about 25 wt %, of a total weight of the dough or biscuit.A biscuit can be prepared from a dough generally including any one or more suitable sweeteners in an amount effective to impart sweetness to a biscuit. Examples of sweeteners include any one or more of natural or artificial sweeteners, such as glucose, fructose, sucrose, lactose, mannose, maltose, fruit sugar, brown sugar, agave nectar, honey, high-fructose corn syrup, molasses, and the like; sugar alcohols such as sorbitol, xylitol, mannitol, maltitol, lactitol, erythritol, and the like; low or zero calorie sweeteners such as aspartame, Acesulfame potassium, Neotame, Stevia leaf extract, monk fruit extract, steviol glycosides, mogrosides, Saccharin, Sucralose, and the like; and mixtures thereof. In some aspects, sweeteners can be ground granulated, powdered (e.g. powdered or confectioners sugar), laminated, inverted sugar syrup, icing sugar, and the like. A dough can generally include any suitable amount of sweetener, such as amounts ranging from about10 wt. % to about 30 wt %, or from about 15 to about 25 wt %, of a total weight of the dough.

A biscuit can be optionally prepared from a dough generally including one or more suitable inclusions such as sugar-based inclusions, gelatinous inclusions, chocolate chips, chocolate drops, fruit, dried fruit, caramel, nuts, such as pecans, almonds, walnuts, cashews, and peanuts, candies, sugar crystals of various sizes, sugar particles, laminated sugar particles, and the like. Any suitable amount of inclusions can be added to the types of dough described herein, such as amounts ranging from 5 to 45 wt %, 10 to 40 wt %, 15 to 35 wt %, or 20 to 30 wt % of a total weight of the biscuit. Inclusions may be provided in some forms in order to mimic desirable characteristics of candy or other food products. For instance, in some aspects, a biscuit can be prepared from a dough including sugar-based or gelatinous inclusions in order to provide a flavor and texture associated with gummy candies. Inclusions can generally comprise any one or more of sweetener, gelling agent, colorant, and one or more acidulants. Inclusions can also, in some embodiments, include or be prepared from any useful gelling agent such as any one or more of starch (e.g. corn starch), modified starch (e.g. acid-modified starch), gelatin, vegetable polysaccharide, alginate (seaweed polysaccharide), alginate salt, alginic acid, algin, or pectin. An example of a useful inclusion is Flavor Islands™ Orange X-small Size-dry (QualiTech, Chaska Minn.), including invert sugar, sugar, water, wheat flour (bleached, niacin, iron, thiamin mononitrate, riboflavin, folic acid), algin, natural flavor, potassium sorbate preservative, and yellow #6. An inclusion can generally comprise any one or more colorants. An inclusion can generally include any one or more suitable colorants imparting colors such as yellow, blue, orange, green, red, pink or purple. An inclusion may also include coatings or other materials on the surface of, or embedded within, the inclusion. In some aspects can include any one or more suitable food grade acidulants such as acetic acid, ascorbic acid, oxalic acid, tartaric acid, citric acid, or malic acid, and salts thereof including ammonium, calcium, potassium and sodium salts thereof. In an embodiment, a biscuit can be prepared from a dough including gelled inclusions having color, flavor and texture of Sour Patch Kids candy.

A dough can optionally include other additives such as any one or more of baking powder (e.g. ammonium phosphate), colorants, emulsifiers (e.g. lecithin), hydrocolloids, preservatives, salt, whey, and browning inhibitors (e.g. sodium metabisulphate). Without intending to be bound by any particular theory, it is thought that the high ionic concentrations minimizes the degree to which whey protein undesirably self-aggregates or forms networks.

In general, a biscuit can be prepared from a dough comprising material derived from one or more acids or salts thereof. Material derived from one or more acids and salts thereof can generally include any one or more of a dissociated acid, a non-dissociated acid, a dissociated salt, a non-dissociated salt, etc. A biscuit can be prepared from a dough including any suitable amount of material derived from one or more acids and salts thereof, such as amounts ranging from 0.25 to 2.0 wt %, 0.5 to 1.0 wt %, or 0.7 to 0.8 wt % of a total weight of the dough.

Generally, any acid or salt thereof can include one or more ionizable groups. An acid or salt thereof including a single ionizable group can have a single pKa. An acid or salt thereof including more than one ionizable group can have a different pKa value for each ionizable group. A biscuit can be prepared from a dough comprising any suitable material derived from one or more acids or salts thereof including at least one ionizable group having any suitable pKa, such as a pKa of less than 6.5, less than 6.0, less than 5.5, less than 5.0, less than 4.5, less than 4.0, less than 3.5, less than 3.0, less than 2.5, less than 2.0, or less than 1.5. In some aspects, a dough can include at least 1 wt % of material derived from one or more acids and salts thereof having at least one ionizable group having a pKa of less than 6.5, of less than 5.0 or of less than 4.0. In other aspects, a dough can include at least 0.25 wt % of material derived from one or more acids and salts thereof having at least one ionizable group having a pKa ranging from 3.5 to 5.0. In some preferred embodiments, the total amount of such material derived from acids and salts thereof is about 1.0 wt. % of the dough.

In some embodiments, one or more acids and/or salts thereof used in a dough according to the present disclosure can have a thermal decomposition temperature of least about 170° C., at least about 180° C., at least about 190° C., at least about 195° C., at least about 200° C., at least about 210° C., at least about 215° C., at least about 220° C. Without intending to be bound by any particular theory, it is thought that acids having higher thermal decomposition temperature are less likely to generate unsightly brown speckling on a surface of a baked biscuit. It has been found that tartaric acid having a thermal decomposition of 170° C. decomposes during baking and produces undesirable brown speckling on a surface of a baked good. On the other hand, citric acid has a thermal decomposition temperature of 212° C.

In some embodiments, a useful acid or salt thereof can have a solubility in water of at least about 0.3 grams, at least about 0.4 grams, at least about 0.5 grams, at least about 0.6 grams, at least about 0.7 grams, at least about 0.8 grams, at least about 0.9 grams, at least about 1 grams, at least about 1.1 grams, at least about 1.2 grams, at least about 1.3 grams, or at least about 1.4 grams of acid or salt thereof per gram of water at 20° C. In preferred forms, the solubility of the acid or salt thereof of at least lg/g water.

A biscuit can generally be prepared from a dough comprising material derived from one or more suitable food-grade acids and or salts thereof. Examples of useful acids include acetic acid, ascorbic acid, citric acid, malic acid, oxalic acid, tartaric acid and salts thereof such as ammonium, calcium, potassium and sodium salts thereof. In some embodiments, a biscuit is prepared from a dough comprising material derived from one or more of citric acid, malic acid, and salts thereof.

A dough can generally be formed by mixing components such as water, flour, fat, sweetener, leavening agent, one or more acids or salts thereof and other optional materials. However, it has been generally thought that acids or salts thereof need to be encapsulated by wax or gelatin during conventional dough mixing processes so that they are unable to dissolve and thus interfere with normal dough development and cookie baking. The inventors have surprisingly found that a method of making a dough comprising dissolving one or more acids or salts thereof in water to form an acidic solution and before adding the acidic solution to other components of dough can provide a baked good, e.g. biscuit, with superior characteristics such as taste, appearance, texture, and geometry. Without intending to be bound by any particular theory, it is thought that encapsulation of acids, salts thereof, or undissolved acid powder should be avoidedby dissolving acids or salts thereof in water and then adding the acidic solution to other components such as flour and carbonate/bicarbonate salts that tend to encapsulate the acids or salts thereof. Without intending to be bound by any particular theory, it is generally thought that when one or more acids or salts thereof are encapsulated, or acid powders are not pre-dissolved before mixing with other ingredients of a dough, the encapsulated acidic material or undissolved acid powder form discrete areas of high concentration of the acids or salts thereof. As a biscuit bakes, the areas of high concentration of acid or salts thereof in turn brown and form unsightly brown blotches on the cookie.

In some aspects, one or more acids or salts thereof can be added to and dissolved in water alone or with other non-encapsulating components of a dough such as one or more of sweetener, fat, or leavening agent. Dissolution of one or more acids or salts thereof in water allows preparation of a uniform acidic solution including a dispersion of acids or salts thereof. When the acidic solution is added to flour and other components of a dough, the dispersion helps distribute acids and salts thereof within the flour to avoid encapsulation. Therefore, baked goods having mottled appearance associated with burning of encapsulated acids or salts there can be avoided. The acidic solution can then be added with other components of a dough such as flour and carbonate/bicarbonate salt. In some embodiments, a method of making a dough comprises adding sweetener, fat, a leavening agent, and one or more acids or salts thereof to water to form an acidic solution. The method then comprises, after dissolution of the one or more acids or salts thereof in the water, combining the acidic solution with flour and one or more of a carbonate salt and a bicarbonate salt. After combining all components of a dough, the dough can generally be mixed in any useful manner. After mixing a dough, the dough can be optionally kneaded and allowed to lay. It is generally thought that allowing dough to lay for a conventional period of time, e.g. 90 minutes, permits complete hydration of flour, i.e. gluten, within the dough. Without intending to be bound by any particular theory, it is thought that the complete hydration of gluten in a dough also including material derived from one or more acids or salts thereof adversely affects the spread of the dough during baking, and adversely affects the flavor and texture of a baked good prepared from such a dough.

Therefore, in some aspects of a method of making a biscuit, a dough is permitted to lay for a period less than is required for complete hydration of the flour or gluten in the dough. In some aspects, a dough is permitted to lay for less than about 60 minutes, less than about 55 minutes, less than about 50 minutes, less than about 45 minutes, less than about 40 minutes, less than about 35 minutes, less than about 30 minutes, less than about 25 minutes, less than about 20 minutes, less than about 15 minutes, and optionally from about 10 to about 45 minutes, about 12 to about 40 minutes, about 15 to about 35 minutes, about 25 to about 35 minutes, or about 15 to about 30 minutes.

Any optional inclusions can generally be added at any time during making or processing of a dough. For example, inclusions can be added when mixing components of a dough, after mixing components of a dough, or after allowing a dough to lay.

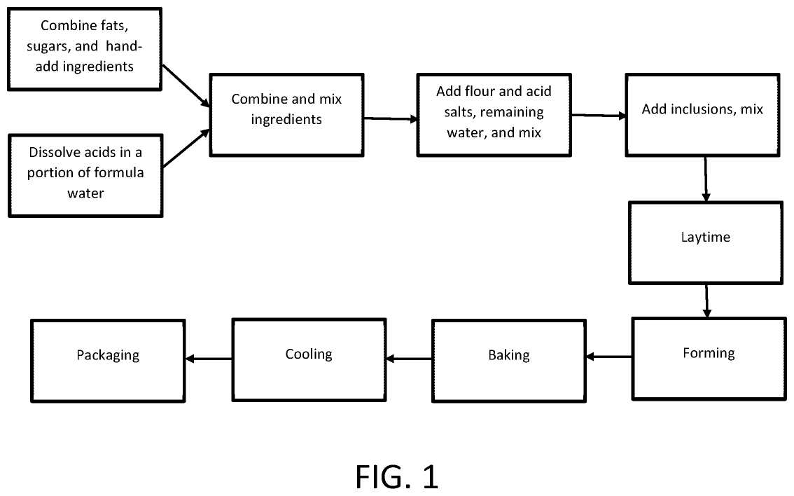

FIG. 1 is a process flow diagram of one embodiment of a method of making a baked good. Components including fats, sugar, and other hand-added ingredients such as salt, syrups, and emulsifiers (e.g. lecithin) are added to a mixer. Next, one or more acids or salts thereof are separately dissolved in water. The resulting acidic solution is then added to the mixer. In some forms, the aforementioned ingredients are mixed to form a cream, for instance by mixing for at least about 4 minutes. The remaining water and any remaining components (for instance, other bicarbonate/carbonate salt and flour) and are added to the mixer. Flour is then added to the mixture and one or more of a carbonate salt and a bicarbonate salt is added on top of the flour. The components are then mixed. Mixing for about 5-6 minutes is generally sufficient, although any mixing time that results in a relatively homogenous distribution of ingredients may be used. Without intending to be bound by any theory, it is thought that addition of one or more of a carbonate salt and a bicarbonate salt on top of flour allows the carbon dioxide generated during mixing with the acidic solution to be entrained within the dough. Optional inclusions and flavoring can be added in and mixed in the dough at this stage. After mixing, the dough is kneaded and allowed to lay for the desired time, preferably less than about 60 minutes, and more preferably about 15-30 minutes. Next the dough is formed into the desired shape and weight and placed in an oven for baking. Instruments and methods for baking generally known in the art for baking of biscuits may be employed. After baking, the baked good is cooled and then packaged for shipping and, sale.

### EXAMPLE 1

A dough for preparing a biscuit was prepared by mixing the following components in a mixer:

| Ingredient | | Before | After |
|---|---|---|---|
| Target dough temp- 67° F. | Weight | Baking | Baking |
| Fat | 46.50 | 16.53% | 17.65% |
| Whey | 1.00 | 0.36% | 0.36% |
| Sucrose | 43.03 | 15.09% | 16.2% |
| Molasses | 1.50 | 0.53% | 0.47% |
| Salt | 0.70 | 0.25% | 0.27% |
| Lecithin | 0.50 | 0.18% | 0.19% |
| Sodium Bicarbonate | 1.98 | 0.70% | 0.38% |
| Regular Cookie Flour | 100.00 | 35.56% | 32.89% |
| Ammonium Bicarbonate | 1.98 | 0.70% | 0.00% |
| Diammonium Phosphate | 0.38 | 0.14% | 0.00% |
| Citric Acid | 1.98 | 0.70% | 0.75% |
| Malic Acid/Tartaric Acid | 0.66 | 0.23% | 0.25% |
| Mono Calcium Acid Phosphate | 0.99 | 0.35% | 0.37% |
| Invert | 2.88 | 1.02% | 0.78% |
| Water | 16.50 | 5.87% | 3.15% |
| Flavored Inclusions | 66.08 | 23.50% | 25.08% |

Citric and malic/tartaric acids and monocalcium acid phosphate from the above formulation were dissolved in a portion of the formula water to create an acidic solution. Fat, whey, sucrose, molasses, salt, and lecithin were separately combined in a mixer, to which the acidic solution was then added. The ingredients were then mixed for 4 minutes. Flour, sodium bicarbonate, ammonium bicarbonate, diammonium phosphate, and the remaining formula water were then added to the mixer, and the ingredients were then mixed for about 6 minutes. As the flour became hydrated, flavored inclusions were added and mixed with the other components. After mixing was complete, the resulting dough was allowed to lay for 30 minutes before dividing into uniform shapes and then baked via multi-stage radiant heating.

### EXAMPLE 2

Table 1 shows the relationship between amount of added calcium acid phosphate and pH and moisture in inventive cookies and control cookie. Cookie 0 was a traditional chocolate-chip cookie dough that did not contain flavor acids such as citric and malic/tartaric acids. Cookie 1 was an experimental sample made according to the formulation and process described above in Example 1. Cookie 2 was a second experimental sample identical to cookie 1, except that it included twice the amount of sodium bicarbonate, ammonium bicarbonate, diammonium phosphate, and monocalcium acid phosphate. Cookie 3 was a comparative high-acid example made from dough made according to the formulation in Example 1 except that it omitted diammonium phosphate and contained only about 1 g bicarbonate per 100 g flour. Unlike Cookie 0, Cookie 3 included citric and malic/tartaric acids in the amounts identified in Example 1.

Table 1 below illustrates that addition of 1 to 2 grams of calcium acid phosphate per 100 g of flour in high acid cookies 1 and 2 provided moisture content comparable to control Cookie 0 having no flavor acids whereas not adding calcium acid phosphate to high-acid Cookie 3 had undesirably high moisture content.

TABLE 1

| | Amount of calcium | | | Cookie | Cookie |
|---|---|---|---|---|---|
| Cookie | acid phosphate | Cookie | Cookie | density, | color, |
| No. | added to flour | pH | moisture | g/cm3 | L* |
| 0 | 0 g/100 g flour | 7.5 | 4.2 | 4.85 | 47.8 |
| | (low acid control) | | | | |
| 1 | 1 g/100 g flour | 6.6 | 4.4 | 5.39 | 40.1 |
| 2 | 2 g/100 g flour | 6.0 | 4.3 | 5.25 | 40.8 |
| 3 | 0 g/100 g flour | 5.0 | 5.1 | 5.45 | 46.6 |
| | (high acid | | | | |
| | comparative) | | | | |

This demonstrates that moisture removal and cookie geometry during baking similar to those of regular cookies can be achieved in high-acid cookies can be achieved with addition of bicarbonate and acid phosphate salts, leading to normal baked cookie flavor and texture. Table 1 also shows that addition of calcium acid phosphate reduced cookie density of high-acid cookies.

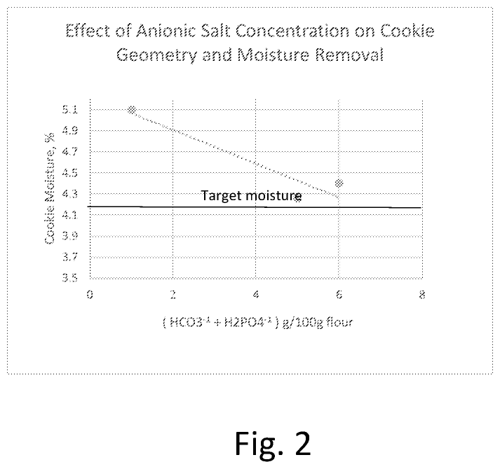

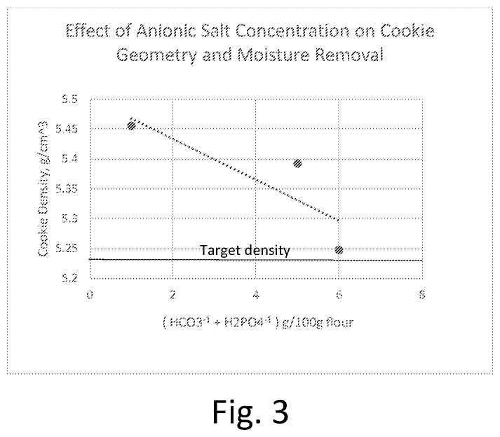

The above changes moisture and density in high-acid cookies based on addition of anionic salts is shown graphically in FIGS. 2-3. FIG. 2 is a graph showing a relationship between moisture and total concentration of bicarbonate and dihydrogen phosphate ions in cookies having increased acid and specified amounts of anionic salts, based on measurements from Cookies 1-3 above. FIG. 3 is similarly a graph showing a relationship between density and total concentration of bicarbonate ions and dihydrogen phosphate ions in control cookies having increased acid and specified amounts of anionic salts, based on measurements form Cookies 1-3 above. FIGS. 1 and 2 show the effect of the concentration of the anions on cookie geometry and finished moisture. Cookies having higher density tend to suffer from inadequate spread during baking. As shown in FIGS. 2 and 3, cookies having bicarbonate ion and dihydrogen phosphate ion concentrations ranging from 4 g/100 g of flour to 6.5 g/100 g flour tend to provide satisfactory moisture removal and density after baking. Below this range, cookies tend to have undesirably high moisture and density. Above 6.5 g/100 g flour, a cookie has off flavors, texture becomes fragile, and the cookie falls apart.

What is claimed is:

1. A biscuit prepared from a dough, the dough comprising, excluding any inclusions:
30 to 60 wt % of flour,
15 to 30 wt % of fat,
10 to 30 wt % of sweetener,
0.25 to 2.0 wt % of material derived from one or more acids or salts thereof having a pKa of less than 6.5; and
a total bicarbonate ion and dihydrogen phosphate ion concentration ranging from 4 g/100 g of flour to 6.5 g/100 g flour.

2. The biscuit according to claim 1, the one or more acids or salts thereof having a pKa ranging from 3.5 to 5.5.

3. The biscuit according to claim 1, the one or more acids or salts thereof having a pKa of less than 4.0.

4. The biscuit according to claim 1, the one or more acids or salts thereof having a solubility in water of at least 1 gram per gram of water at 20° C.

5. The biscuit according to claim 1, the one or more acids or salts thereof having a thermal decomposition temperature of at least 170° C.

6. The biscuit according to claim 1, the one or more acids or salts thereof comprising one or more of oxalic acid, acetic acid, tartaric acid, malic acid, citric acid, ascorbic acid, and salts thereof.

7. The biscuit according to claim 1, the one or more acids or salts thereof comprising one or more of citric acid, malic acid, and salts thereof.

8. The biscuit according to claim 1, further comprising one or more acidic leavening agents in an amount ranging from about 0.5 g/100 g flour to 4 g/100 g flour.

9. The biscuit according to claim 1, further comprising native wheat starch. The biscuit according to claim 1, the biscuit comprising 15 to 35 wt % of inclusions.

11. The biscuit of claim 10, the inclusions comprising sweetener, colorant, and acidulant.

12. A method of making a dough, the method comprising:
combining water, one or more sugars, one or more oils, and one or more acids or salts thereof in water to form an acidic solution, the one or more acids or salts thereof having a pKa of less than 5.0, and combining the acidic solution to flour to form a dough.

13. The method according to claim 12, wherein after mixing the dough comprises:
30 to 60 wt % of flour,
15 to 30 wt % of fat,
10 to 30 wt % of sweetener, and
0.25 to 2.0 wt % of material derived from the one or more acids or salts thereof;
and wherein the dough has a total bicarbonate ion and dihydrogen phosphate ion concentration ranging from 4 g/100 g of flour to 6.5 g/100 g flour.

14. The method according to claim 13, further comprising adding inclusions to the dough, the inclusions being added in an amount of 15 to 35 wt % of the dough.

15. The method according to claim 14, the inclusions comprising gelatinous inclusions including sweetener, gelling agent, colorant, and acidulant.

16. The method according to claim 12, the one or more acids or salts thereof having a solubility in water of at least 0.3 gram per gram of water at 20° C.

17. The method according to claim 12, the one or more acids or salts thereof having a thermal decomposition temperature of at least 170° C.

18. The method according to claim 12, the one or more acids or salts thereof comprising one or more of oxalic acid, acetic acid, tartaric acid, malic acid, citric acid, ascorbic acid, and salts thereof.

19. The method according to claim 12, the one or more acids or salts thereof comprising one or more of citric acid, malic acid, and salts thereof.
